(19) United States
(12) Patent Application Publication
(10) Pub. No.: US 2025/0235963 A1
(43) Pub. Date: Jul. 24, 2025

(54) Battery Powered Weld Bead Cutter

(71) Applicant: Milwaukee Electric Tool Corporation, Brookfield, WI (US)

(72) Inventors: Michael R. Rohrer, Milwaukee, WI (US); Terry L. Timmons, JR., Oconomowoc, WI (US)

(21) Appl. No.: 19/028,033

(22) Filed: Jan. 17, 2025

Related U.S. Application Data
(60) Provisional application No. 63/555,642, filed on Feb. 20, 2024.
(60) Provisional application No. 63/622,708, filed on Jan. 19, 2024.

(51) Int. Cl. B23K 37/08

(52) U.S. Cl. CPC B23K 37/08

(57) ABSTRACT

Various embodiments of a battery powered weld bead cutter are provided. The weld bead cutter includes a body, a weld bead cutting head coupled to the body and a power tool battery receptacle on the body. The weld bead cutter includes a motor supported within the body. The motor is configured to rotatably drive a drive shaft to provide a cutting movement to the weld bead cutting head. A power tool battery is couplable to the power tool battery receptacle to supply power to the motor.

### CROSS-REFERENCE TO RELATED PATENT APPLICATIONS

The present application claims the benefit of and priority to U.S. Provisional Application No. 63/555,642, filed Feb. 20, 2024, and to U.S. Provisional Application No. 63/622,708, filed Jan. 19, 2024, which are incorporated herein by reference in their entities.

### BACKGROUND OF THE INVENTION

The present disclosure is directed generally to battery powered tools. The present disclosure relates specifically to a battery powered weld bead cutter.

### SUMMARY OF THE INVENTION

One embodiment of the invention relates to a weld bead cutter. The weld bead cutter includes a body, a cutting head coupled to the body, and battery receptacle on the body. The body includes a first and a second end opposing the first end. The cutting head is coupled to the first end of the body and includes a cutter. The cutter has an outer surface configured to remove material. The weld bead cutter includes a motor supported within the body. The motor is engaged with a drive shaft. The drive shaft provides movement to the cutting head. The weld bead cutter further includes a battery coupled to the battery receptacle, the battery receptacle is configured to supply power to the motor.

Another embodiment of the invention relates to a power tool. The power tool includes a body, a cutting head coupled to the body, and a battery receptacle positioned on the body. The body includes a first and a second end opposing the first end. The cutting head is coupled to the first end of the body and includes a generally cylindrical cutter. The weld bead cutter includes a motor supported within the body, the motor is engaged with a drive shaft. A gear box is positioned between the body and the cutting head. The gear box is engaged with the drive shaft and includes an input shaft and an output shaft. The input shaft is coupled to one or more gears and extends along a first axis. The output shaft is engaged with the input shaft and extends along a second axis. The second axis is different than the first axis. The battery receptacle is configured to supply power to the motor when a battery is coupled to the battery receptacle.

Another embodiment of the invention relates to a power tool. The power tool includes a body, a cutting head coupled to the body, and a battery receptacle positioned on the body. The body includes a first and a second end opposing the first end. The cutting head is coupled to the first end of the body and includes a cutter. The cutter is moveable about an axis of rotation. The weld bead cutter includes an adjustment foot. The axis of rotation of the cutter is positioned between the adjustment foot and the body. The adjustment foot is moveable such that a distance between the cutter and a work surface is changed. The weld bead cutter includes a motor supported within the body, the motor is engaged with a drive shaft. The drive shaft is configured to provide movement to the cutting head. The battery receptacle is configured to supply power to the motor when a battery is coupled to the battery receptacle.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 shows a right perspective view of a weld bead cutter, according to an exemplary embodiment.

FIG. 2 shows a top, left perspective view of the weld bead cutter of FIG. 1, according to an exemplary embodiment.

FIG. 3 is a partial exploded rear perspective view of the weld bead cutter of FIG. 1, according to an exemplary embodiment.

FIG. 4 shows a right perspective view of the weld bead cutter of FIG. 1 with a portion of the housing removed, according to an exemplary embodiment.

FIG. 5 is a bottom perspective view of the weld bead cutter of FIG. 4, according to an exemplary embodiment.

FIG. 6 is a partially exploded view of the weld bead cutter of FIG. 1, according to an exemplary embodiment.

FIG. 7 is an exploded view of a foot assembly of the weld bead cutter of FIG. 1, according to an exemplary embodiment.

FIG. 8 is a rear view of the cutting head with a portion of the housing removed, according to an exemplary embodiment.

FIG. 9 is a perspective view of the weld bead cutter of FIG. 1 with a portion of the handle removed, according to an exemplary embodiment.

FIG. 10 is a perspective view of the weld bead cutter of FIG. 1 with a portion of the handle and the foot assembly removed, according to an exemplary embodiment.

FIG. 11 is a detailed view of a portion of the gear box of the weld bead cutter of FIG. 1, according to an exemplary embodiment.

### DETAILED DESCRIPTION

Referring generally to the figures, various embodiments of a battery powered weld bead cutter are provided. In contrast to typical weld bead cutters that use pneumatic power, the weld bead cutter discussed herein includes a power tool battery receptacle configured to receive a power tool battery that provide power to the tool. As will be generally understood, pneumatic tools require access to an air compressor for operation that may be inconvenient to move around large work or job sites. Further, pneumatic tools are relatively loud compared to electric power tools. Applicant believes use of a battery to power a weld bead cutter provides improved convenience since an air compressor is not necessary and reduces noise made during use of the weld bead cutter.

In various embodiments, the weld bead cutter head discuss herein includes a foot allowing for additional adjustment of the depth of the weld bead. While some weld bead cutters include depth adjustment, Applicant believes the adjustable foot discussed herein provides increased control of the cutter. Specifically, the adjustable foot includes a first angled portion and a second angled portion that together form a beveled section. Applicant believes the beveled section provides additional control of the depth of the weld bead when the depth of the cutter is not perfectly set before use of the weld bead cutter.

Additionally, in various embodiments, the weld bead cutter includes a right angle gear box between the body and head. Applicant believes the right angle gear box provides an improvement over conventional weld bead cutters and/or grinders that have different types of gear boxes. As will be generally understood, right angle gear boxes can be used in a smaller more limited spaces while still having the ability to handle high torques. Therefore, Applicant believes the right angle gear box allows for reduction in the size of the weld bead cutter. In a specific embodiment, the gear box is a planetary gear box. Applicant believes the planetary gear box further allows for a compact size and reduced weight of the weld bead cutter while maintaining a high power density.

In various embodiments, the weld bead cutter includes a locked off paddle switch coupled to the body in contrast to the variable speed switch typically used with pneumatic weld bead cutters.

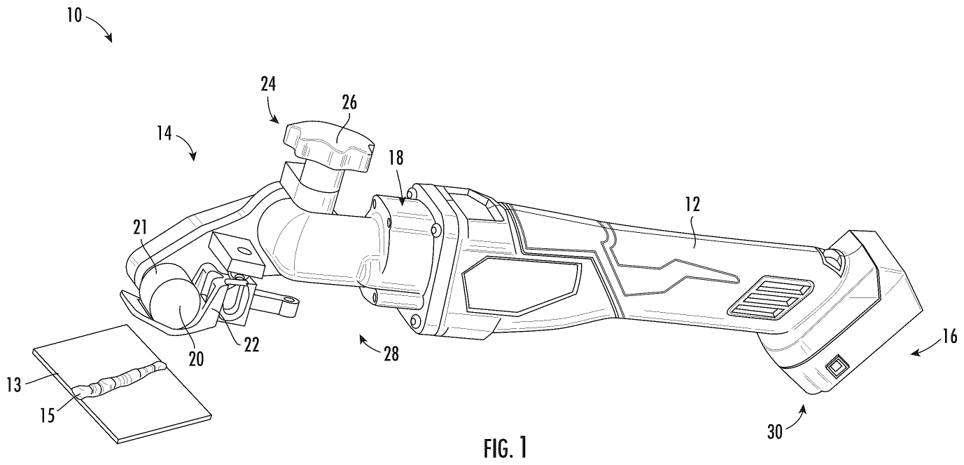

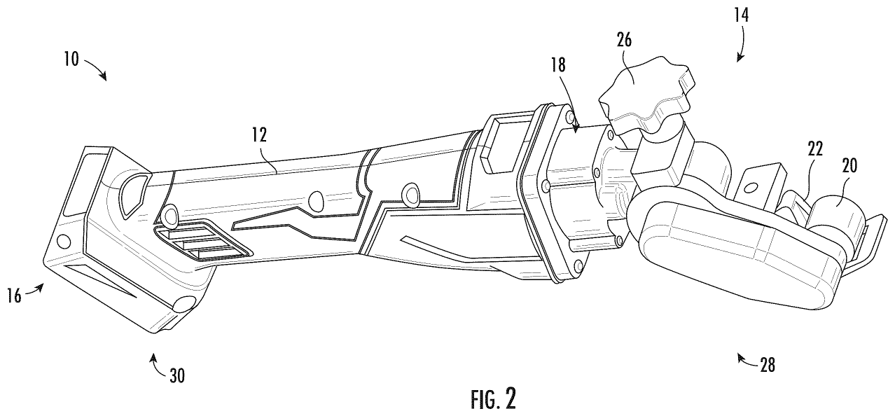

Referring to FIGS. 1-2 perspective views of a portable power tool, shown as weld bead cutter 10, according to an exemplary embodiment. Weld bead cutter 10 includes a handle or body 12 and a cutting head 14 coupled to body 12. Weld bead cutter 10 has a first cutting end 28 and a second, opposing handle end 30. A power source receptacle, shown as a battery receptacle 16 is positioned at handle end 30. A gear box housing 18 extends between and connects cutting head 14 to body 12 of weld bead cutter 10.

As will be generally understood, the weld bead cutter 10 discussed herein is not a direct drive tool (i.e., load is not directly connected to a motor) or a saw. Cutting head 14 includes a cutter 20 having a cutting surface 21. Cutter 20 is configured to cut or grind down excess welding material 15 that is produced during the welding process. As will be generally understood, when structures and/or surfaces 13 are welded together such as in a butt weld, excess reinforcement may result in unnecessary welding material 15. In other words, welding material not necessary to hold the structures together may extends upward relative to the other surfaces of the welded structures.

In various embodiments, cutting surface 21 includes a plurality of ridges. In such an embodiment, the ridges provide for a more uniform or smooth surface finish. In various specific embodiments, the cutter 20 is formed from one of Carbide, high speed tool steel, Cobalt, etc. In a specific embodiment, cutter 20 is generally cylindrical in shape. In various embodiments, cutter 20 is one of a raked tooth cutter, a bonded abrasive element, and a compressed stone element (e.g., grinding stone).

Weld bead cutter 10 further includes an adjustment assembly 24 that provides for adjustment of the position of cutter 20 relative to the work surface 13, shown schematically (i.e., welded surface to be cut). The adjustment assembly includes a knob 26 that allows for raising and/or lowering of the cutting head 14 and cutter 20. Weld bead cutter 10 further includes an adjustment foot 22 providing for additional adjustment of cutter 20. As will be discussed in greater detail below, Applicant believes the adjustment foot 22 provides for more fine adjustment of the distance between the cutter 20 and the work surface (i.e., the depth for the weld bead cut).

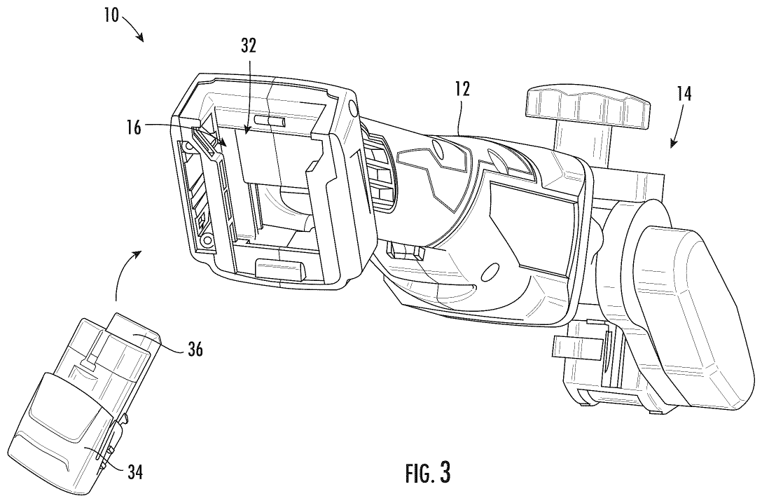

Referring to FIG. 3, a rear perspective view of weld bead cutter 10 is shown according to an exemplary embodiment. Handle end 30 and specifically battery receptacle 16 includes a recessed portion 32 configured to connect to a power source, shown as battery 34. In various specific embodiments, battery 34 has an engagement portion 36 configured to engage with the recessed portion 32 of the battery receptacle 16.

Specifically, battery receptacle 16 is configured to selectively mechanically and electrically connect to battery 34. In a specific embodiment, the battery 34 is insertable into recessed portion 32 of battery receptacle 16 such that battery 34 is oriented along the longitudinal axis of body 12. In another specific embodiment, battery 34 is insertable into recessed portion 32 of battery receptacle 16 such that battery 34 is oriented in a transverse direction relative to the longitudinal axis of body 12. In a specific embodiment, battery 34 is a rechargeable battery. In various embodiment, battery 34 has one of a number of nominal voltages (e.g., 12 V, 18V, etc.) and is configured having any one of a number of chemistries (e.g., lithium-ion, nickel-cadmium, etc.).

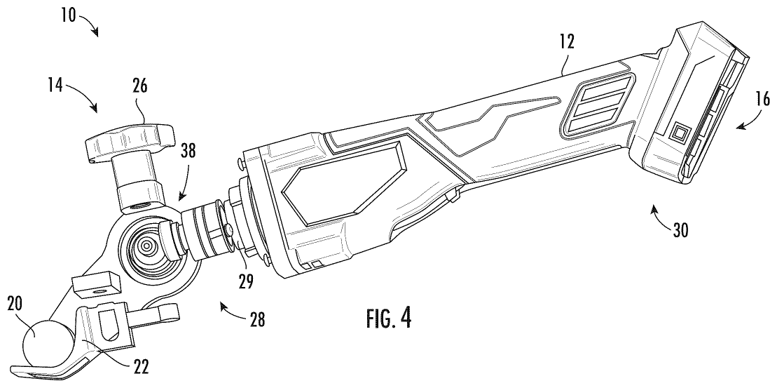

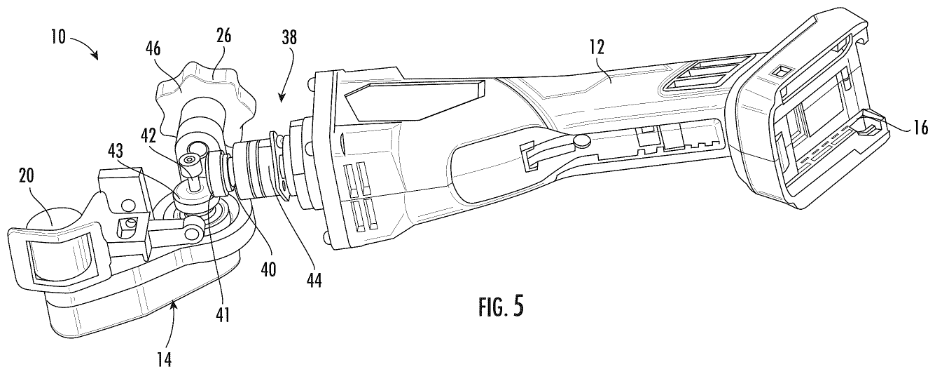

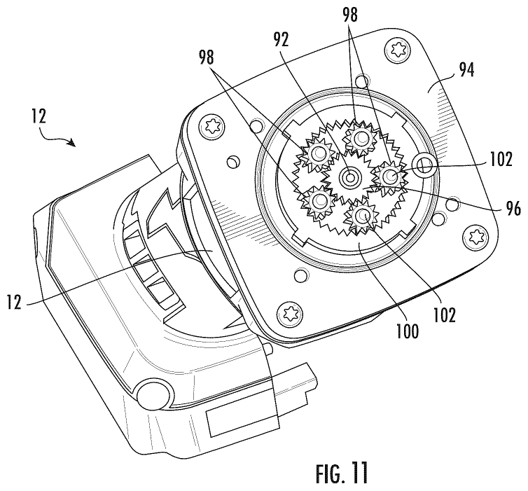

Referring to FIGS. 4-6, details of the gearing arrangement of weld bead cutter 10 are shown, according to an exemplary embodiment. As shown in FIGS. 4-5, when gear box housing 18 is removed, a gearing system or gear box shown as a right angle gearing system 38 is visible. In various embodiments, the gearing system 38 has a gear ratio of 1:1. Such embodiments are in contrast to grinding tools which typically have a smaller gear ratio. In various specific embodiments, the gearing system 38 is between the cutting head 14 and the body 12. The gearing system 38 is configured to engage the drive shaft (see e.g., 92). As will be discussed in greater detail below, the gearing system 38 includes an input shaft 40 engaged and/or coupled to one or more gears (see e.g., 96, 98, 100 in FIG. 11) and an output shaft 42 engaged with the input shaft 40. In various specific embodiments, input shaft 40 includes a first bevel gear 41 engaged with a second bevel gear 43 of output shaft 42. In various other embodiments, input shaft 40 and output shaft 42 may be engaged using a different type of gear (e.g., spur gears, etc.).

The input shaft 40 extends along a first axis 44 and the output shaft 42 extends along a second axis 46. In various embodiments, the first axis 44 is different than the second axis 46. In other words, the first axis 44 is not colinear with second axis 46. In a specific embodiment, the first axis 44 is generally perpendicular (e.g., 90 degree plus or minus 10 degrees) to the second axis 46. In various embodiments, the orientation between first axis 44 and second axis 46 is between 0 and 180 degrees and more specifically between 45 and 135 degrees. In various specific embodiments, the input shaft 40 extends in a generally parallel orientation to the drive shaft of the motor.

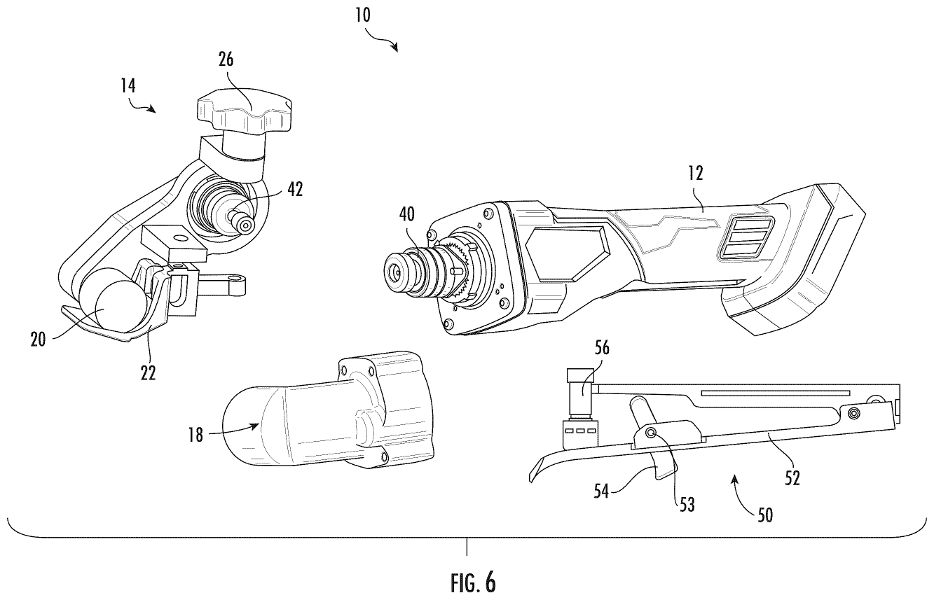

Referring to FIG. 6, details of trigger assembly 50 are shown according to an exemplary embodiment. Body 12 supports trigger assembly 50. Trigger assembly 50 is moveable to allow for selective electrical connection between motor 90 and battery 34. Weld bead cutter 10 includes control electronics (e.g., switch 58, PCBA 84, etc.).

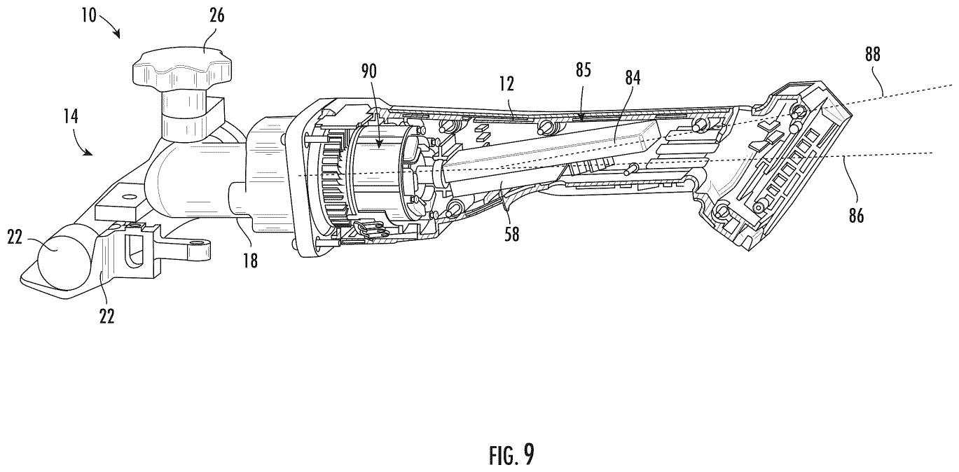

As will be generally understood, the trigger assembly 50 is a “lock-off” trigger assembly including a paddle member 52 and a lock-off member 54 that is supported by paddle member 52. The paddle member 52 is operable to engage an actuator 56 that will actuate a switch 58 (see e.g., FIG. 9). In various embodiments, the switch 58 is an electrical switch (e.g., a microswitch). The switch 58 selectively engages and disengages the motor 90 during operation of the weld bead cutter 10. The lock-off member 54 selectively prevents operation and/or movement of paddle member 52. Specifically, lock-off member 54 is pivotable to selectively lock and unlock the paddle member 52. In other words, paddle member 52 is moveable between a first position in which the switch 58 is disengaged and a second position in which the switch 58 is engaged. When the switch 58 is disengaged the motor 90 is deactivated and when the switch 58 is engaged the motor is activated or turned on.

In various embodiments, paddle member 52 is pivotably supported relative to body 12 such that a user can press paddle member 52 to engage motor 90 and operate weld bead cutter 10. In various specific embodiments, lock-off member 54 extends through an opening in paddle member 52 and coupled to paddle member 52 using a fastener 53.

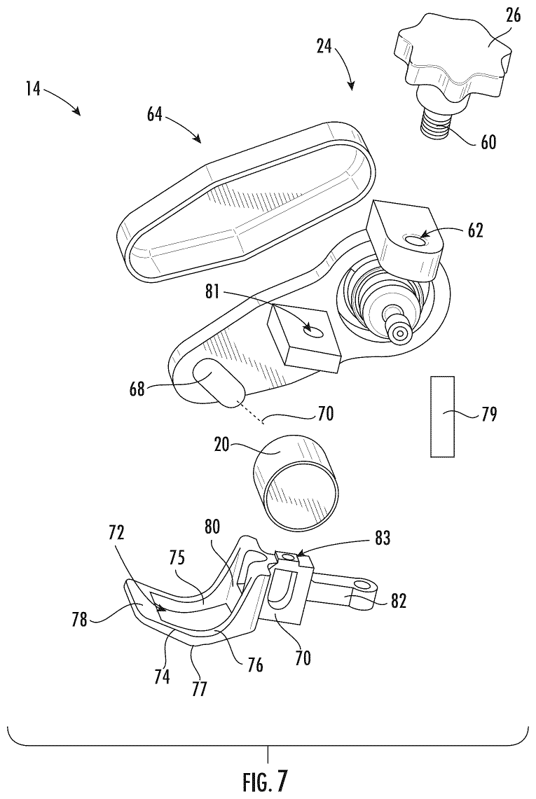

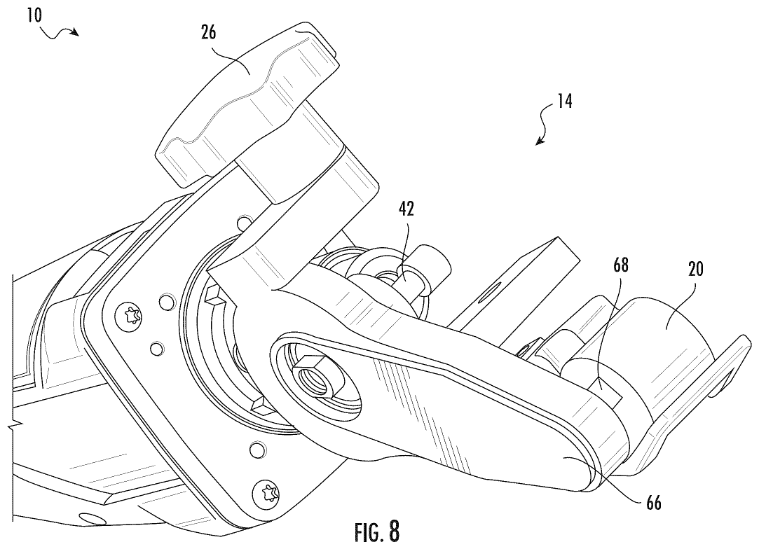

Referring to FIGS. 7-8, details of cutting head 14 are shown, according to an exemplary embodiment. Adjustment assembly 24 further includes a threaded shaft 60 coupled to knob 26. Threaded shaft 60 is configured to be received within a threaded bore 62. When a user turns knob 26 in a first direction, cutting head 14 is lowered towards the work surface and or weld. When a user turns knob 26 in a second direction, opposite the first direction, cutting head 14 is raised or moved away from the work surface or weld. In other words, the knob 26 enables a user to choose a distance between the cutter 20 and work surface or the depth that the cutter 20 will cut into the weld bead or excess weld material.

A belt drive 66 transfers a torque from the gear box 38 to the cutter 20. Specifically, belt drive 66 transfers the torque from output shaft 42. In various specific embodiments, the belt drive 66 is positioned between gear box 38 and the cutter 20 (e.g., after the gear box). In various embodiments, belt drive 66 may be positioned between motor 90 and gear box 38. As will generally be understood, weld bead cutters are different than grinding tools because they are belt driven.

In a specific embodiment, cutter 20 is rotatably coupled to cutting head 14 by a shaft or axle 68. In various other embodiments, cutter 20 is coupled to a shaft or axle that extends from body 12.

Cutter 20 rotates about a cutting axis 70 (i.e., rotational axis of cutter 20) that is defined along a longitudinal axis of shaft 68. In various specific embodiments, the belt drive 66 drive has perpendicular orientation relative to the motor 90. In various specific embodiments, belt drive 66 is enclosed within cutting head 14 by housing portion 64.

Referring to FIG. 7, details of adjustment foot 22 are shown, according to an exemplary embodiment. Adjustment foot 22 includes an opening defined 73 between a pair of opposing sidewalls 75. Each of the opposing sidewalls 75 includes a first angled portion 74 and a second angled portion 76 connected to the first angled portion 74. Each sidewall 75 extends between a front portion 78 of adjustment foot 22 and a rear wall 80. First angled portion 74 is coupled to front portion 78 while second angled portion 76 of sidewall 75 is positioned between first angled portion 74 and rear wall 80.

The first angled portion 74 and second angled portion 76 together define a beveled surface 77 of sidewall 75. In the specific embodiment shown in FIG. 7, beveled surface 77 is a downward facing surface when weld bead cutter 10 and specifically foot 22 is oriented as shown in FIG. 7. Adjustment foot 22 further includes a lever arm 82 projecting from rear wall 80. A connector 79, shown schematically, extends through bore 81 of cutting head 14 and bore 83 of adjustment foot 22 to couple adjustment foot 22 to cutting head 14. Connector 79 allows for moveable connection between adjustment foot 22 and cutting head 14. In various specific embodiments, connector 79 allows for translatable movement of foot 22 relative to gear box 38.

When a user provides a force on lever arm 82, a distance between cutter 20 and the weld surface is adjusted (e.g., increased or decreased). The axis of rotation 70 of the cutter 20 is positioned between the adjustment foot 22 and the body 12. The adjustment foot 22 is moveable such that a distance between the cutter 20 and a work surface 13 (sec e.g., FIG. 1) is changed.

As previously noted, Applicant believes the beveled surface 77 allows for further modification of cutter 20 position and depth of cut in addition to the use of knob 26. In various embodiments, adjustable foot 22 allows for small or fine adjustments of cutter 20.

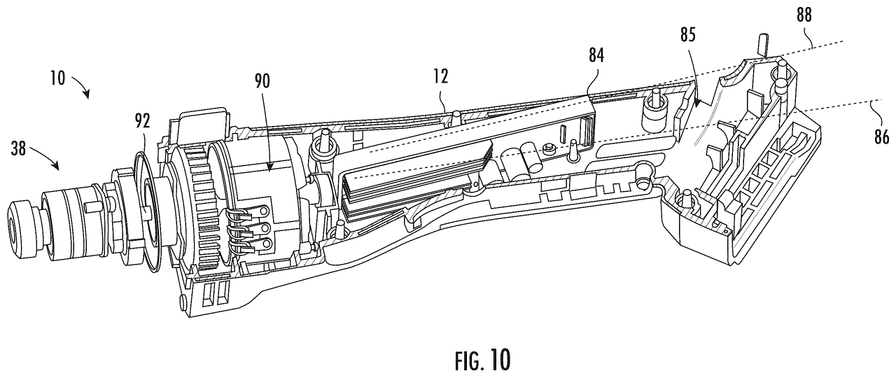

Referring to FIGS. 9-10, details of body 12 are shown, according to an exemplary embodiment. Body 12 defines a cavity 85. A printed circuit board assembly (PCBA) 84 is supported within cavity 85 of body 12 along with switch 58. Body 12 includes a longitudinal axis 86. PCBA 84 includes a longitudinal axis 88 that is angled relative to longitudinal axis 86 of body 12. Motor 90 is supported within body 12 in cavity 85.

Motor 90 engages a drive shaft 92 that extends generally along longitudinal axis 86 of body 12 defining a motor axis. In various embodiments, motor 90 includes a rotor and a stator that surrounds the rotor. In such an embodiment, the stator is supported within body 12 and remains stationary relative to body 12 during operation of weld bead cutter 10. The rotor is rotatably fixed to the drive shaft 92 and configured to co-rotated with the drive shaft 92 about the motor axis. A distal portion of the drive shaft 92 extends from the housing and engages gear box 38.

Referring to FIG. 11, further details of gear box 38 are shown, according to an exemplary embodiment. In the illustrated embodiment, the gear box 38 includes a planetary gear system. In other embodiments, the gear system can be a different type of gear system.

A cover plate 94 is positioned between body 12 and cutting head 14. A ring gear 100 is coupled to cover plate 94. Gear box 38 further includes a center or sun gear 96. One or more side or planet gears 98 are positioned around center gear 96. In a specific embodiment, five planet gears 98 are positioned around center gear 96 and between center gear 96 and ring gear 100. In various other embodiments, a different number of planet gears 98 can be used (e.g., 3, 4, 6, etc.). Each planet gear 98 is engaged with a shaft 102 extending through the middle of the planet gear 98. Each of the shafts 102 are coupled to a carrier 29 (see e.g., FIG. 4).

Carrier 29 is positioned between ring gear 100 and input shaft 40. Carrier 29 is coupled to input shaft 40 such that the rotation from carrier 29 is transmitted to input shaft 40. The gear ratio of the planetary gears is greater than 1:1.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A weld bead cutter comprising:
a body comprising:
a first end; and
a second end opposing the first end;
a cutting head coupled to the first end of the body, the cutting head comprising:
a cutter comprising an outer surface configured to remove material;
a battery receptacle positioned on the body;
a motor supported within the body, the motor engaged with a drive shaft, wherein the drive shaft provides movement to the cutting head; and
a battery coupled to the battery receptacle, the battery configured to supply power to the motor.

2. The weld bead cutter of claim 1, wherein the cutting head further comprises an adjustment foot, wherein a rotational axis of the cutter is positioned between the adjustment foot and the body, wherein a position of the adjustment foot is moveable such that a distance between the cutter and a work surface is modified.

3. The weld bead cutter of claim 2, wherein the adjustment foot comprises:
an opening defined between a pair of opposing sidewalls, wherein each of the opposing sidewalls comprises:
a first angled portion; and
a second angled portion connected to the first angled portion.

4. The weld bead cutter of claim 3, wherein the first angled portion and the second angled portion together define a beveled surface of each sidewall.

5. The weld bead cutter of claim 2, wherein the adjustment foot further comprises a lever arm projecting from a rear wall of the adjustment foot, wherein, when a force is provided on the lever arm, the distance between the cutter and the work surface is changed.

6. The weld bead cutter of claim 1, further comprising a gear box positioned between the body and the cutting head, wherein the gear box engages the drive shaft, and wherein a belt drive transfers a torque from the gear box to the cutter.

7. The weld bead cutter of claim 6, wherein the gear box is a planetary gear box.

8. The weld bead cutter of claim 1, wherein the cutter is one of a raked tooth cutter, a bonded abrasive element, and a grinding stone.

9. A power tool comprising:
a body comprising:
a first end; and
a second end opposing the first end;
a cutting head coupled to the first end of the body, the cutting head comprising:
a generally cylindrical cutter;
a battery receptacle positioned on the body;
a motor supported within the body, the motor engaged with a drive shaft;
a gear box positioned between the body and the cutting head, the gear box engaged with the drive shaft, the gear box comprising:
an input shaft coupled to one or more gears, the input shaft extending along a first axis; and
an output shaft engaged with the input shaft, the output shaft extends along a second axis, wherein the second axis is different than the first axis; and
wherein the battery receptacle is configured to supply power to the motor when a battery is coupled to the battery receptacle.

10. The power tool of claim 9, wherein the first axis of the input shaft is generally perpendicular to the second axis of the output shaft.

11. The power tool of claim 9, wherein the input shaft extends in a generally parallel orientation to the drive shaft.

12. The power tool of claim 9, further comprising a belt drive, wherein the belt drive transmits a torque from the gear box to the cutter.

13. The power tool of claim 12, wherein the belt drive has a perpendicular orientation relative to the motor.

14. The power tool of claim 9, wherein the second axis is oriented at an angle relative to the first axis, and wherein the angle is between 45 and 135 degrees.

15. A power tool comprising:
a body comprising:
a first end; and
a second end opposing the first end;
a cutting head coupled to the first end of the body, the cutting head comprising:
a cutter, the cutter moveable about an axis of rotation; and
an adjustment foot, wherein the axis of rotation of the cutter is positioned between the adjustment foot and the body, wherein the adjustment foot is moveable such that a distance between the cutter and a work surface is changed;
a battery receptacle positioned on the body;
a motor supported within the body, the motor engaged with a drive shaft, wherein the drive shaft is configured to provide movement to the cutting head; and
wherein the battery receptacle is configured to supply power to the motor when a battery is coupled to the battery receptacle.

16. The power tool of claim 15, wherein the cutting head further comprises an adjustment assembly, the adjustment assembly comprising:
a knob; and
a threaded shaft coupled to the knob.

17. The power tool of claim 16, wherein, when the knob is actuated in a first direction, the cutting head is move toward the work surface and wherein, when the knob is actuated in a second direct, the cutting head is moved away from the work surface.

18. The power tool of claim 15, wherein the adjustment foot further comprises:
a sidewall, the sidewall comprising:
a first angled portion; and
a second angled portion connected to the first angled portion, wherein the first angled portion and the second angled portion together define a beveled surface of the sidewall.

19. The power tool of claim 18, wherein the beveled surface faces away from the cutter.

20. The power tool of claim 15 further comprising a right angle gear box positioned between the body and the cutting head, wherein the gear box engages the drive shaft.
